(19) United States
(12) Patent Application Publication
(10) Pub. No.: US 2022/0301250 A1
(43) Pub. Date: Sep. 22, 2022

(54) AVATAR-BASED INTERACTION SERVICE METHOD AND APPARATUS

(71) Applicant: DMLab. CO., LTD, Seoul (KR)

(72) Inventors: Han Seok KO, Seoul (KR); Jeong Min BAE, Seoul (KR); Miguel ALBA, Seoul (KR); David LEE, Seoul (KR)

(21) Appl. No.: 17/506,734

(22) Filed: Oct. 21, 2021

(30) Foreign Application Priority Data
Mar. 17, 2021 (KR) 10-2021-0034756
Sep. 29, 2021 (KR) 10-2021-0128734

(51) Int. Cl. G06T 13/40; G06N 20/00

(52) U.S. Cl. CPC G06T 13/40; G06N 20/00

(57) ABSTRACT

Provided is an avatar-based interaction service method performed by a computer system including: providing an interaction service to a first user terminal through an avatar of a service provider reflecting an image and a voice of the service provider in a non-face-to-face conversation environment between the service provider and a first user; training a response of the service provider to the first user based on a pre-stored learning model; and providing the interaction service to a second user terminal by generating an artificial intelligence (AI) avatar based on the trained learning model.

### BACKGROUND

### Field

The present disclosure relates to an avatar-based interaction service method and apparatus.

### Description of the Related Art

An avatar is a word that means an alter or incarnation, and is an animation character that replaces a user's role in cyberspace.

Most of the existing avatars are two-dimensional pictures. Two-dimensional avatars appearing in mud games and online chats are the most rudimentary. Therefore, an avatar that compensates for the problem of poor reality has emerged. These characters can have a sense of reality and/or a three-dimensional effect.

Recently, with the development of artificial intelligence technology and sensor technology, a need for avatar technology that practically interacts and communicates with humans has emerged.

### SUMMARY

One embodiment of the present disclosure is to provide an avatar-based interaction service method and apparatus that practically interact with humans.

According to an aspect of the present disclosure, there is provided an avatar-based interaction service method performed by a computer system including: providing an interaction service to a first user terminal through an avatar of a service provider reflecting an image and a voice of the service provider in a non-face-to-face conversation environment between the service provider and a first user; training a response of the service provider to the first user based on a pre-stored learning model; and providing the interaction service to a second user terminal by generating an artificial intelligence (AI) avatar based on the trained learning model.

In an exemplary embodiment, the avatar-based interaction service method may further include selecting and databasing content related to an interaction service field from the image and voice of the service provider.

In an exemplary embodiment, the interaction service field may include a customer service, counseling, education, and entertainment, and the interaction service may provide content for the field to the first user terminal or the second user terminal through the interaction based on the avatar.

In an exemplary embodiment, in the providing of the interaction service to the first user terminal through the avatar of the service provider, the image of the service provider may be analyzed to reflect a motion, a gesture, and an emotion of the service provider to the avatar.

In an exemplary embodiment, in the providing of the interaction service to the first user terminal through the avatar of the service provider, the voice of the service provider may be analyzed to modulate the voice of the service provider into a voice of an avatar character and provide the modulated voice to the first user terminal.

In an exemplary embodiment, in the providing of the interaction service to the second user terminal by generating the artificial intelligence (AI) avatar, a facial expression, a gesture, and a voice tone may be analyzed from the image of the second user received from the second user terminal to perceive an emotional state of the second user so as to change a facial expression, a gesture, and a voice tone of the AI avatar in response to the perceived emotional state or attach an effect.

In an exemplary embodiment, in the providing of the interaction service to the second user terminal by generating the artificial intelligence (AI) avatar, the voice of the second user received from the second user terminal may be recognized, understood, and responded to through any one or more of automatic speech recognition (ASR), speech-to-text (STT), natural language understanding (NLU) and text-to-speech (TTS).

According to another aspect of the present disclosure, there is provided an avatar-based interaction service apparatus including: a communication unit configured to transmit and receive information through a communication network with a plurality of user terminals; a real-time interaction unit configured to provide an interaction service to a first user terminal through an avatar of a service provider reflecting an image and a voice of a service provider in a non-face-to-face conversation environment between the service provider and a first user; a learning unit configured to train a response of the service provider to a first user based on a pre-stored learning model; and an AI avatar interaction unit configured to generate an artificial intelligence (AI) avatar based on the trained learning model and allow the AI avatar to provide an interaction service to a second user terminal through the communication unit.

In an exemplary embodiment, the avatar-based interaction service apparatus may further include a content selector configured to select and database content related to an interaction service field from the image and voice of the service provider.

According to another aspect of the present disclosure, there is provided an avatar-based interaction service method performed by a computer system, the method comprising: providing an interaction service to a user terminal through an avatar reflecting an image and a voice generated by the computer system in a non-face-to-face conversation environment between the user at the user terminal and the avatar generated by the computer system; receiving inputs from the user terminal; and generating an avatar response based on the inputs received from the user terminal; and sending the avatar response to the user terminal. According to another aspect of the present disclosure, there is provided an avatar-based interaction service apparatus, comprising: a communication unit configured to transmit and receive information through a communication network to a user terminal; an avatar interaction unit configured to generate an avatar to provide an interaction service to the user terminal through the communication unit; and a real-time interaction unit configured to provide an interaction service to the user terminal through the avatar in a non-face-to-face conversation environment between the avatar and a user at the user terminal.

The effects of the present disclosure are not limited to the aforementioned effects, and various other effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a configuration of a network environment according to an exemplary embodiment of the present disclosure;

FIG. 2 is a block diagram illustrating a configuration of an interaction service server according to an exemplary embodiment of the present disclosure;

FIG. 3 is a block configuration diagram of a terminal according to an exemplary embodiment of the present specification;

FIG. 4 is a block diagram illustrating an example of components that may be included in a control unit of the interaction service server according to the exemplary embodiment of the present specification;

FIG. 5 is a flowchart illustrating an example of a method performed by a control unit of an interaction service server according to an exemplary embodiment of the present disclosure;

FIG. 6 is a diagram for describing an example of implementing an education field of an avatar-based interaction service method according to an exemplary embodiment of the present disclosure;

FIG. 7 is a diagram for describing an example of implementing a customer service field of an avatar-based interaction service method according to an exemplary embodiment of the present disclosure; and

FIG. 8 is a diagram for describing an example of implementing a rehabilitation field of an avatar-based interaction service method according to an exemplary embodiment of the present disclosure.

### DETAILED DESCRIPTION OF THE PREFERRED EMBODIMENT

The present disclosure may be variously modified and have several exemplary embodiments. Therefore, specific exemplary embodiments of the present disclosure will be described in detail with reference to the accompanying drawings. In describing each drawing, similar reference numerals are used for similar components.

Terms such as ‘first’, ‘second’, ‘A’, ‘B’, and the like, may be used to describe various components, but the components are not to be interpreted to be limited to the terms. The terms are used only to distinguish one component from another component. For example, a first component may be named a second component and the second component may also be similarly named the first component, without departing from the scope of the present disclosure. A term ‘and/or’ includes a combination of a plurality of related described items or any one of the plurality of related described items.

Through the present specification and claims, unless explicitly described otherwise, “comprising” any components will be understood to imply the inclusion of other components rather than the exclusion of any other components.

An interaction service server according to an exemplary embodiment of the present disclosure is implemented to be virtual agents allowing a human or an artificial intelligent system that allows other mechanisms to interact between the human and the artificial intelligent mechanism.

Hereinafter, the present disclosure will be described with reference to the accompanying drawings.

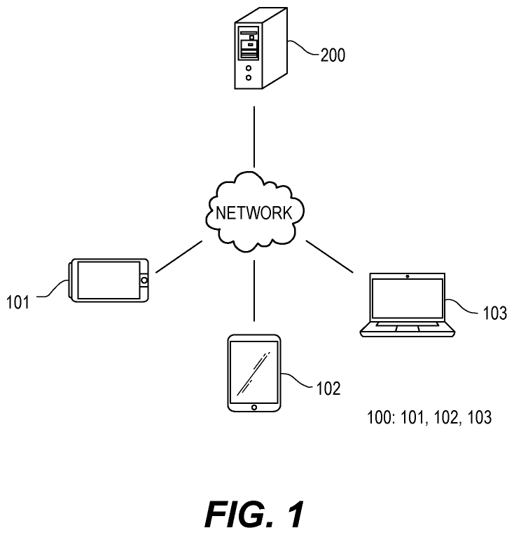

FIG. 1 is a diagram illustrating a configuration of a network environment according to an exemplary embodiment of the present disclosure.

The network environment of FIG. 1 includes a plurality of user terminals 100 (101, 102, and 103) and an interaction service server 200. Hereinafter, for convenience of explanation, the user terminal 101 is referred to as a service provider terminal. FIG. 1 is an example for describing the present disclosure, and the number of user terminals is not limited as illustrated in FIG. 1. In some embodiments, there may only be a single user terminal and in others there may be more than three user terminals.

The plurality of user terminals 100 (101, 102, and 103) are terminals that access the interaction service server 200 through a communication network, and may be implemented as electrical devices that may perform other communications such as mobile phones, smart phones, personal digital assistants (PDAs), a personal computer (PC), a tablet personal computer, and a notebook, receive a user's input, and output a screen, or devices similar thereto.

The communication network may be implemented using at least some of TCP/IP, a local area network (LAN), WIFI, long term evolution (LTE), wideband code division multiple access (WCDMA), other wired communication methods that are already known or will be known in the future, wireless communication methods, and other communication methods. Although many communications are performed through a communication network, in the description to be described later, a reference to the communication network is omitted for concise description.

The interaction service server 200 may be implemented as a computer device or a plurality of computer devices that communicates with the plurality of user terminals 100 through a communication network to provide instructions, codes, files, content, services, and the like. For example, the interaction service server 200 may provide an interaction service targeted by an application as a computer program installed and driven in a plurality of user terminals 100 accessed through a communication network. Here, the interaction service is defined as a service that provides content for a certain field between service provider terminal (101) and user terminal (102) or between a user terminal (103) and an avatar generated by service server 200 (without the need of another user terminal). The field may include a customer service, counseling, education, and entertainment. For example, when the field is education, the service provider may be a teacher, and the first user may be a student. The interaction service server 200 may generate an avatar reflecting an image and a voice of a teacher from service provider terminal 101 in a non-face-to-face conversation environment between, service provider, as the teacher; and the the first user as a student at first user terminal 102, and provide the generated avatar to the student at the first user terminal 102. In this way, a student may feel a learning experience from an avatar. This also allows the teacher and student to be in remote locations. In addition, the interaction service server 200 may generate an AI avatar by training a response of a first user who is a teacher in the non-face-to-face conversation environment. Once trained or pre-programmed, it is possible to perform learning guidance on the second user terminal as the student (103), without access from the service provider terminal 101 as the teacher, through the AI avatar in the non-face-to-face conversation environment. In this embodiment, once the AI avatar is trained or pre-programmed, there is no need for user terminals 101 or 102. One benefit of using an avatar is that in some cases children are more responsive to an avatar rather than a person. This could be especially helpful in instances where a child had bad experiences with teachers, but is more comfortable speaking to an avatar in the form of their favorite animal such as a friendly panda bear or koala.

In addition, the interaction service server 200 may distribute files for installing and running the above-described application to a plurality of user terminals 100.

Although the example given is between a teacher and a student, this could have wide applications in many areas such as taking an order at a restaurant, a coffee shop, a fast food restaurant, a drive through etc. Other areas of applicability are interactions with personal trainers, doctors, psychiatrists, advisors, lawyers, entertainers etc. In short in any instance there is an interaction for a service or for communication, an avatar can be used. This could be a computer generated avatar or an avatar based on a person's real-time response to the interaction/communication.

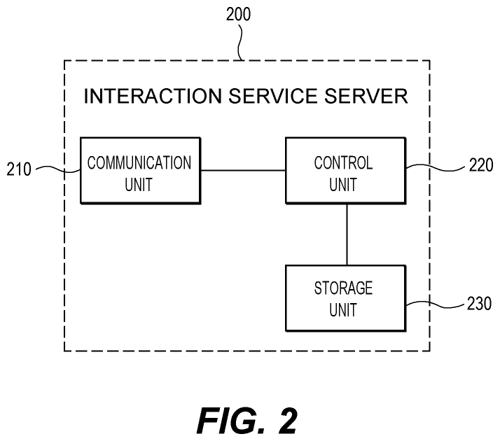

FIG. 2 is a block diagram illustrating a configuration of an interaction service server according to an exemplary embodiment of the present disclosure.

Referring to FIG. 2, the interaction service server 200 according to an exemplary embodiment of the present specification may include a communication unit 210, a control unit 220, and a storage unit 230.

The communication unit 210 is a data transmission/reception device provided in the interaction service server 200 and transmits and receives information for an interaction service between different user terminals through a communication network.

The communication unit 210 exchanges data with the user terminal (100 in FIG. 1) and/or other external devices. The communication unit 210 transmits the received data to the control unit 220. In addition, the communication unit 210 transmits data to the user terminal 100 under the control of the control unit 220. The communication technology used by the communication unit 210 may vary depending on a type of communication network or other circumstances.

The communication unit 210 may receive an image and a voice of the service provider and the first user, for example, as information for real-time interaction between the service provider terminal and the first user terminal accessed.

In addition, the communication unit 210 may transmit information for displaying an avatar on the first user terminal as information for providing an interaction service to the first user terminal accessed.

The control unit 220 may be configured to perform basic arithmetic, logic, and input/output operations to process instructions of a computer program in order to control the overall operation of the interaction service server 200 and each component. The instruction may be provided to the control unit 220 through the storage unit 230 or the communication unit 210. For example, the control unit 220 may be a processor configured to execute an instruction received according to a program code stored in a storage device such as the storage unit 230.

In particular, as will be described later, the control unit 220 may render an image and a voice of a service provider acquired from the service provider terminal, which are received by the communication unit 210, into a 3D animated version of the avatar. The voice of the avatar can be synchronized (at the same time) with an output of a rendering engine. In some embodiments it is not necessary to have a service provider terminal. Instead the control unit 220 renders an image and voice of an avatar without the use of a service provider terminal.

In particular, as will be described later, the control unit 220 may train the image and voice of the service provider acquired from the service provider terminal, which are received by the communication unit 210, with a pre-stored learning model, thereby generating an avatar. In addition, the control unit 220 selects content related to an interaction service field from the image and voice of the service provider, and databases the selected content in the storage unit 230, which will be described later.

In an exemplary embodiment, the control unit 220 may provide the interaction service to the user terminal, which has accessed based on the databased content, through the avatar.

In order to provide a sense of life to the user, the avatar according to an exemplary embodiment makes eye contact by exchanging glances during a conversation with a user, and enables casual conversations, thereby enabling colloquial language conversation. In addition, the avatar may possess the ability for everyday conversations, for question and answer formats to elicit active responses, and for realistic casual conversations by harnessing the power of memory from past conversations with a user.

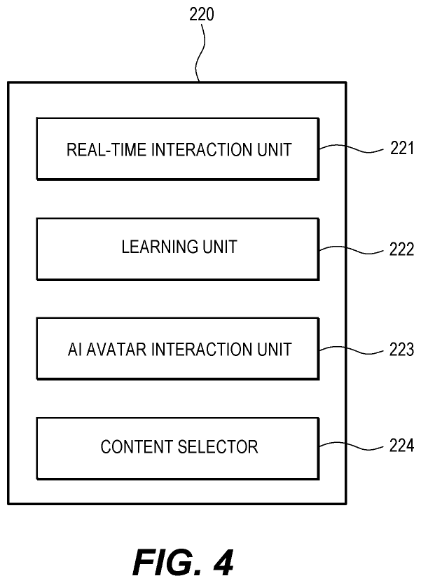

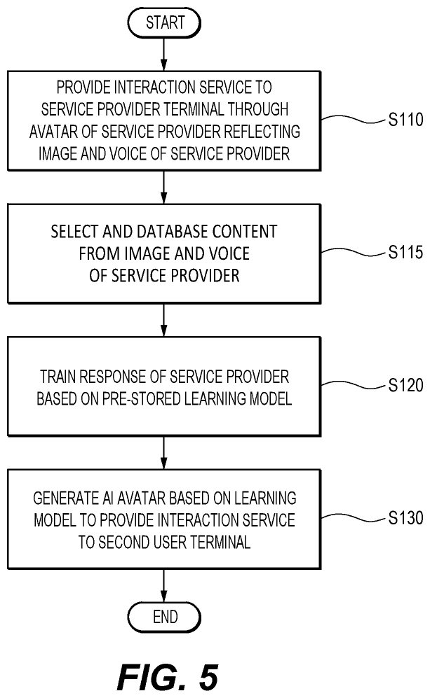

In addition, the avatar system may perform emotional recognition that recognizes an emotional state of a user through facial expressions, gestures, and voice tones of the user, and may perform an emotional expression that expresses emotions of the avatar through the appropriate determination of the response to the recognized emotion, the selection of the voice tone for each emotion corresponding to the facial expression, and the choice of the right word. The implementation of such an avatar will be described later with reference to FIGS. 4 and 5.

In an exemplary embodiment, the control unit 220 may transmit data, video, and audio in real time in a peer-to-peer (P2P) manner by applying web real-time communication (WebRTC) or any other mechanism that may enable real-time interactions between two or more entities over a network.

The storage unit 230 serves to store programs and data necessary for the operation of the interaction service server 200 and may be divided into a program area and a data area.

The program area may store a program controlling the overall operation of the interaction service server 200, an operating system (OS) booting the interaction service server 200, at least one program code (for example, a code for a browser installed and driven in the user terminal 100, an application installed in the user terminal 100 to provide a specific service, or the like), a learning model for training an avatar, an application program required to provide an interaction service, and the like.

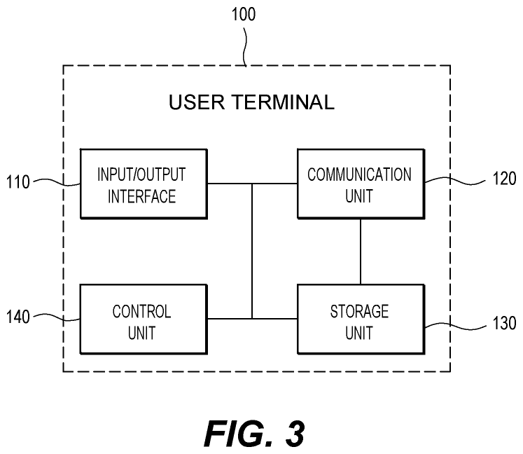

FIG. 3 is a block configuration diagram of a terminal according to an exemplary embodiment of the present specification.

Referring to FIG. 4, the user terminal 100 according to an exemplary embodiment of the present specification may include an input/output interface 110, a communication unit 120, a storage unit 130, and a control unit 140.

The input/output interface 110 may be a means for an interface with an input/output device. For example, the input device may include a device such as a keyboard, a mouse, a microphone array, and a camera, and the output device may include a device such as a display or a speaker.

Here, the microphone array may include 3 to 5 microphones. One of the microphones may be used for voice recognition, and the other microphones may be used for beam forming or any other technique that allows directional signal reception. By applying the beam forming, robust voice recognition performance may be secured from a signal with noise. The camera may be any one of a camera that does not include a depth sensor, a stereo camera, and a camera that includes a depth sensor. In the case of using the camera including the depth sensor, a foreground or background limit may be selected to limit detection of a person or object in the background, thereby setting an area in which the camera may focus on a person who approaches a device.

In another exemplary embodiment, the input/output device may further include an artificial tactile nerve, an olfactory sensor, an artificial cell membrane electronic tongue, or the like in order to implement an avatar similar to a human.

As another example, the input/output interface 110 may be a means for interfacing with a device, in which input and output functions are integrated into one, such as a touch screen. The input/output device may be constituted as one device with the user terminal 100.

As a more specific example, when the control unit 140 of the service provider 101 processes an instruction of a computer program loaded in the storage unit 130, a service screen or content configured using data provided by the interaction service server 200 or the first user terminal 102 may be displayed on a display through the input/output interface 110.

The communication unit 120 exchanges data with the interaction service server 200. The communication unit 120 transmits data received from the interaction service server 200 to the control unit 140. In addition, the communication unit 120 transmits data to the interaction service server 200 under the control of the control unit 140. The communication technology used by the communication unit 120 may vary depending on a type of communication network or other circumstances.

The storage unit 130 stores data under the control of the control unit 140 and transmits the requested data to the control unit 140.

The control unit 140 controls the overall operation of the terminal 100 and each component. In particular, as described later, the control unit 140 controls to transmit an image and a voice of a user input from the input/output interface 110 to the interaction service server 200 through the communication unit 120, and to display an avatar on the input/output device according to the information received from the interaction service server 200.

FIG. 4 is a block diagram illustrating an example of components that may be included in the control unit of the interaction service server according to the exemplary embodiment of the present specification, and FIG. 5 is a flowchart illustrating an example of a method performed by a control unit of an interaction service server according to an exemplary embodiment of the present disclosure.

The interaction service server 200 according to an exemplary embodiment of the present disclosure may also serve as an information platform that provides information on various fields through an avatar. In other words, the interaction service server 200 serves as a platform for providing the information on various fields to the user terminal 100. The interaction service server 200 may display an avatar while linking with an application installed in the user terminal 100 and provide information by interacting with the avatar.

In order to perform an avatar interaction service method of FIG. 5, as illustrated in FIG. 4, the control unit 220 of the interaction service server 200 may include a real-time interaction unit 221, a learning unit 222, and an AI avatar interaction unit 223 and may further include a content selection unit 224. According to the exemplary embodiment, components of the control unit 220 may be selectively included in or excluded from the control unit 220. In addition, according to the exemplary embodiment, components of the control unit 220 may be separated or merged to express the function of the control unit 220.

The control unit 220 and the components of the control unit 220 may control the interaction service server 200 to perform steps S110 to S140 included in the avatar interaction service method of FIG. 5. For example, the control unit 220 and the components of the control unit 220 may be implemented to execute an instruction according to a code of the operating system included in the storage unit 230 and a code of at least one program.

Here, the components of the control unit 220 may be expressions of different functions of the control unit 220 performed by the control unit 220 according to the instruction provided by the program code stored in the interaction service server 200. For example, the real-time interaction unit 221 may be used as a functional expression of the control unit 220 that controls the interaction service server 200 according to the above-described instruction so that the interaction service server 200 provides a real-time interaction service.

In step S110, the real-time interaction unit 221 provides an interaction service to a first user terminal through an avatar of a service provider reflecting an image and a voice of a service provider in a non-face-to-face conversation environment between the service provider and a first user.

For image analysis, the real-time interaction unit 221 may include a human composition API (HCAPI) component. The HCAPI component is a component that extracts features of the service provider(actor).

The real-time interaction unit 221 may include a background segmenter to exclude information greater than a specific distance from the camera, reduce a probability of erroneous detection, and improve an image processing speed by removing background.

In addition, the real-time interaction unit 221 may include a face recognizer to recognize a speaker, and include a 3D pose sequence estimator to extract a continuous pose feature for recognizing a speaker's current posture and gesture. In addition, the real-time interaction unit 221 may include a multi-object detector to extract information about where an object is in an image on a screen.

The real-time interaction unit 221 may include sound source localization using a microphone array for speech analysis to recognize who a speaker is among a plurality of users, and include a sidelobe canceling beamformer to reduce a side input and prevent erroneous detection by focusing on sound coming from all directions through the microphone. In addition, the real-time interaction unit 221 may include a background noise suppressor to remove background noise.

In one exemplary embodiment, the real-time interaction unit 221 analyzes the image of the service provider acquired from the service provider terminal and reflects a motion, a gesture, and emotion of the service provider to the avatar. In addition, by analyzing the image of the service provider, the voice of the service provider is modulated into a voice of the avatar character and provided to the first user terminal.

Since the time taken to generate the avatar image of the service provider by the real-time interaction unit 221 and the time taken to modulate the voice of the service provider into the voice of the avatar may be different from each other, the real-time interaction unit 221 may include a latency multiplier to delay the modulated voice of the avatar, thereby synchronizing the voice of the avatar with the output of the image of the avatar.

The voice of the avatar is synchronized (at the same time) with an output of a rendering engine.

As a result, the service provider and the first user may perform real-time interaction through respective terminals in a non-face-to-face manner. An avatar reflecting the image of the service provider is displayed on the first user terminal in real time, and the voice of the avatar reflecting the voice of the service provider is output through a speaker or the like.

In step S115, the content selection unit 224 selects content related to the interaction service field from the image and video of the service provider and stores the content in a database to build an information platform.

For example, a content-related keyword may be extracted from a sentence generated based on the voice of the service provider, and a key keyword may be additionally extracted from the extracted keywords using a preset weight for each field. The key keyword may be classified and sorted by indexing each of a plurality of criteria items. As the database is built up, an information platform may be implemented based on the database.

In step S120, the learning unit 222 trains a response of the service provider to the first user based on a learning model in the non-face-to-face conversation environment.

In step 130, the AI avatar interaction unit 223 generates an artificial intelligence (AI) based avatar using the trained learning model and allows the AI avatar to provide an interaction service to a second user terminal through the communication unit.

To this end, the AI avatar interaction unit 223 may recognize, understand, and respond to a voice of a second user received from the second user terminal through at least any one of automatic speech recognition (ASR), speech-to-text (STT), natural language understanding (NLU) and text-to-speech (TTS).

In one exemplary embodiment, the AI avatar interaction unit 223 may recognize a speaker from the image of the third user received from the third user terminal, analyze a facial expression, a gesture, and a voice tone of the speaker to perceive an emotional state of the user so as to change an expression, a gesture, and a voice tone of the avatar in response to the perceived emotional state or attach an effect.

The AI avatar interaction unit 223 may provide the interaction service through the AI avatar based on the above-described databased content. For example, the AI avatar interaction unit 223 may communicate with a user by interlocking with an artificial intelligence (AI) conversation system or provide various information such as weather, news, music, maps, and photos. The artificial intelligence conversation system is applied to a personal assistant system, a chatbot platform, an artificial intelligence (AI) speaker, and the like, and may understand an intention of a user's command and provide information corresponding thereto.

For example, when the AI avatar interaction unit 223 receives a voice input “** dance” according to a user's utterance from the second user terminal 103, the AI avatar interaction unit 223 may recognize and analyze the received voice input to acquire information on the “** dance” and output the acquired information through the AI avatar. In this case, the AI avatar interaction unit 223 may also provide visual information by using a separate pop-up window, a word bubble, a tooltip, or the like in the process of providing the information.

The AI avatar interaction unit 223 may exchange and express emotions with the user by changing the facial expression of the AI avatar. The AI avatar interaction unit 223 may change a facial expression of a character by transforming a facial area of the AI avatar objectized through 3D modeling, and attach various effects to the AI avatar to maximize the expression of the emotion. An effect is content composed of image objects, and may mean covering all of filters, stickers, emojis, etc., and may be implemented not only as a fixed object, but also as a moving image object to which flash, animation, or the like is applied. These effects represent emotional information and may be pre-classified for each emotion. In other words, a plurality of emotions (e.g., joy, sadness, surprise, trouble, suffering, anxiety, fear, disgust, anger, etc.) are defined in advance and effects representing the corresponding emotions may be grouped and managed for each emotion.

The AI avatar interaction unit 223 may extract emotional information from a sentence of a voice input received from a user to express emotion. In this case, the emotional information may include an emotion type and an emotion intensity (feeling degree). Terms representing emotions, that is, emotional terms, may be determined in advance, and classified into a plurality of emotion types (for example, joy, sadness, surprise, trouble, suffering, anxiety, fear, disgust, anger, etc.) according to a predetermined criterion, and classified into a plurality of strength classes (for example, 1 to 10) according to the strength and weakness of the emotional term. The emotional term may include not only a specific word representing emotion, but also a phrase or a sentence including a specific word. For example, words such as ‘like’ or ‘painful,’ or phrases or sentences such as ‘I like you so much’ may be included in a category of emotional terms. As an example, the AI avatar interaction unit 223 may extract a morpheme from a sentence according to a voice input of a user, and then extract a predetermined emotional term from the extracted morpheme, thereby classifying the emotion type and emotion intensity corresponding to the extracted emotion term. When the sentence of the voice input contains a plurality of emotional terms, the weight may be calculated according to the emotion type and the emotion intensity to which the emotional term belongs, so a emotion vector for the emotional information of the sentence may be calculated to extract the emotional information representing the sentence. The technique for extracting the above-described emotional information is exemplary and is not limited thereto, and other well-known techniques may also be used.

In one exemplary embodiment of the present disclosure, it has been described that a third user interacts with an AI avatar through the AI avatar interaction unit 223, but this is only an example, and it may also be implemented so that multiple people may access and interact with the same AI avatar through each user terminal.

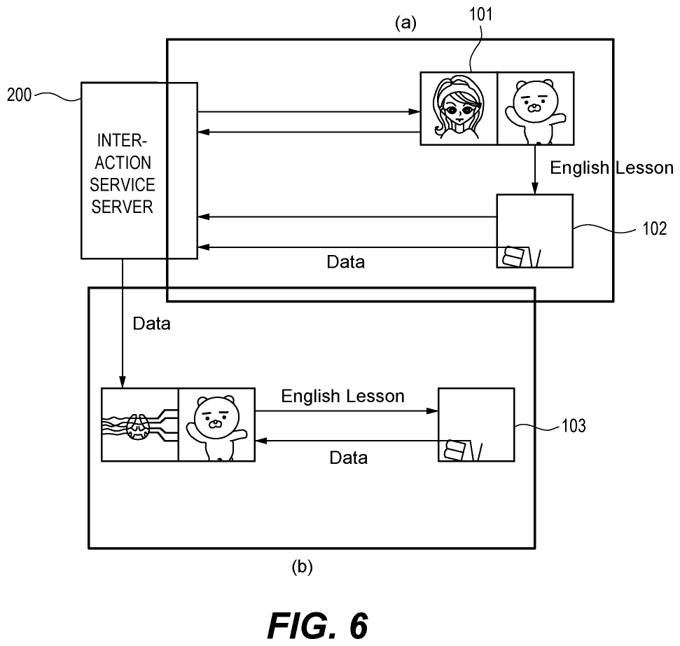

FIG. 6 is a diagram for describing an example of implementing an education field of an avatar-based interaction service method according to an exemplary embodiment of the present disclosure.

An example used in the field of education, especially language education for children, will be described with reference to FIG. 6.

As illustrated in FIG. 6A, a first user terminal 101 as a teacher and a second user terminal 102 as a learner are connected to the interaction service server 200. The interaction service server 200 creates an avatar that follows the facial expressions and gestures of a teacher, who is a person, in real time. In addition, a voice of the teacher is modulated into a voice of an avatar character and output to the second user terminal 102.

In this process, as illustrated in FIG. 6B, the interaction service server 200 collects the image and voice data received from the first user terminal 101 of the teacher and uses the collected image and voice to train the AI avatar, and as a result, may implement a pure artificial intelligence avatar without human intervention using the learning result. Learners may perform learning with artificial intelligence avatars without a teacher.

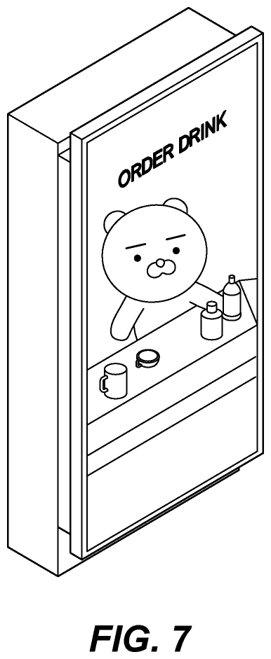

FIG. 7 is a diagram for describing an example of implementing a customer service field of an avatar-based interaction service method according to an exemplary embodiment of the present disclosure.

An example used for ordering in a customer service field, particularly, a cafe, or the like will be described with reference to FIG. 7.

An interface for interacting and reacting like a human may be provided through an AI avatar provided through the interaction service server 200. For example, the AI avatar provided through the interaction service server 200 may provide or recommend a menu to a customer who is a user in a cafe, explain a payment method, and make payment. This allows customers (users) to place orders in a more comfortable and intimate way than a touch screen kiosk.

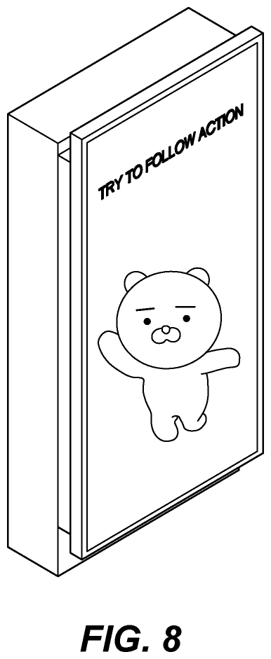

FIG. 8 is a diagram for describing an example of implementing a rehabilitation field of an avatar-based interaction service method according to an exemplary embodiment of the present disclosure.

An example used in the rehabilitation field will be described with reference to FIG. 8.

The AI avatar provided through the interaction service server 200 shows a motion for rehabilitation to a user, analyzes the motion that the user follows, and provides real-time feedback on the posture in a conversational format. In this way, the AI avatar may give feedback in a conversational format in real time while observing the user's posture, so that classes can be conducted at a level of receiving services from real people.

In addition to rehabilitation, the AI avatar may be applied to all exercises such as yoga, Pilates, and Physical Therapy (PT).

In addition, such an interaction service may also be applied to an entertainment field. The interaction service may be implemented to create an avatar with an appearance of a specific singer through 3D modeling, make the created avatar follow a dance of a specific singer through motion capture, and provide performance and interaction content with a voice of a specific singer through TTS and voice cloning.

The devices described hereinabove may be implemented by hardware components, software components, and/or combinations of hardware components and software components. The devices and the components described in the exemplary embodiments may be implemented using one or more general purpose computers or special purpose computers such as a processor, a control unit, an arithmetic logic unit (ALU), a digital signal processor, a microcomputer, a field programmable gate array (FPGA), a programmable logic unit (PLU), a microprocessor, or any other devices that may execute instructions and respond to the instructions. A processing device may execute an operating system (OS) and one or more software applications executed on the operating system. In addition, the processing device may access, store, manipulate, process, and create data in response to execution of software. Although a case in which one processing device is used is described for convenience of understanding, it may be recognized by those skilled in the art that the processing device may include a plurality of processing elements and/or plural types of processing elements. For example, the processing device may include a plurality of processors or one processor and one control unit. In addition, other processing configurations such as parallel processors are also possible.

The software may include computer programs, codes, instructions, or a combination of one or more thereof, and may configure the processing device to be operated as desired or independently or collectively command the processing device to be operated as desired. The software and/or data may be embodied in any type of machine, component, physical device, computer storage medium, or device to be interpreted by the processing device or to provide instructions or data to the processing device. The software may be distributed on computer systems connected to each other by a network to be thus stored or executed by a distributed method. The software and the data may be stored in one or more computer-readable recording media.

The methods according to the exemplary embodiment may be implemented in a form of program instructions that may be executed through various computer means and may be recorded in a computer-readable recording medium. In this case, the medium may be one that continuously stores a program executable by a computer, or temporarily stores a program for execution or download. Further, the medium may be a variety of recording means or storage means in a form in which a single or several pieces of hardware are combined, but is not limited to a medium directly connected to a computer system, but may be distributed on a network. Examples of the medium may include a magnetic medium such as a hard disk, a floppy disk, or a magnetic tape, an optical recording medium such as a compact disk read only memory (CD-ROM) or a digital versatile disk (DVD), a magneto-optical medium such as a floptical disk, and those configured to store program instructions, such as a read only memory (ROM), a random access memory (RAM), or a flash memory. In addition, examples of other media include an app store that distributes applications, a site that supplies or distributes various software, and a recording medium or a storage medium managed by a server or the like.

A friendly interaction service may be provided to a user based on an avatar according to an exemplary embodiment of the present disclosure.

In addition, an avatar may be used for interactive orders at cafes or the like, language education for children, rehabilitation, and entertainment, by maximizing interaction with people through trained AI avatars.

As described above, although the exemplary embodiments have been described by the limited exemplary embodiments and drawings, various modifications and alternations are possible by those of ordinary skill in the art from the above description. For example, even though the described techniques may be performed in a different order than the described method, and/or components of the described systems, structures, devices, circuits, etc. may be combined or combined in a different manner than the described method, or replaced or substituted by other components or equivalents, appropriate results can be achieved.

Therefore, other implementations, other exemplary embodiments, and those equivalent to the claims also fall within the scope of the claims to be described later.

What is claimed is:

1. An avatar-based interaction service method performed by a computer system using a service provider terminal, a first user terminal and a second user terminal, the method comprising:
providing an interaction service to the first user terminal through an avatar reflecting an image and a voice of the service provider from the service provider terminal in a non-face-to-face conversation environment between the service provider at the service provider terminal and a first user at the first user terminal;
training a response of the service provider to the first user based on a pre-stored learning model; and
providing the interaction service to a second user terminal by generating an artificial intelligence (AI) avatar based on the trained learning model.

2. The avatar-based interaction service method of claim 1, further comprising:
selecting and databasing content related to an interaction service field from the image and voice of the service provider.

3. The avatar-based interaction service method of claim 2, wherein the interaction service field includes a customer service, counseling, education, and entertainment, and
the interaction service provides content for the field to the first user terminal or the second user terminal through the interaction based on the avatar.

4. The avatar-based interaction service method of claim 1, wherein in the providing of the interaction service to the first user terminal through the avatar of the service provider, the image of the service provider is analyzed to reflect a motion, a gesture, and an emotion of the service provider to the avatar.

5. The avatar-based interaction service method of claim 1, wherein in the providing of the interaction service to the first user terminal through the avatar of the service provider, the voice of the service provider is modulated into a voice of the avatar character and is provided to the first user terminal.

6. The avatar-based interaction service method of claim 1, wherein in the providing of the interaction service to the second user terminal by generating the artificial intelligence (AI) avatar, a facial expression, a gesture, and a voice tone are analyzed from an image of the second user received from the second user terminal to perceive an emotional state of the second user so as to change a facial expression, a gesture, and a voice tone of the AI avatar in response to the perceived emotional state or attach an effect.

7. The avatar-based interaction service method of claim 1, wherein in the providing of the interaction service to the second user terminal by generating the artificial intelligence (AI) avatar, the voice of the second user received from the second user terminal is recognized, understood, and responded to through any one or more of automatic speech recognition (ASR), speech-to-text (STT), natural language understanding (NLU) and text-to-speech (TTS).

8. An avatar-based interaction service apparatus, comprising:
a communication unit configured to transmit and receive information through a communication network with a service provider terminal, a first user terminal and a second user terminal;
a real-time interaction unit configured to provide an interaction service to the first user terminal through an avatar of a service provider at the service provider terminal reflecting an image and a voice of the service provider in a non-face-to-face conversation environment between the first user and a second user;
a learning unit configured to train a response of the service provider to the first user based on a pre-stored learning model; and
an AI avatar interaction unit configured to generate an artificial intelligence (AI) avatar based on the trained learning model and allow the AI avatar to provide an interaction service to the second user terminal through the communication unit.

9. The avatar-based interaction service apparatus of claim 8, further comprising:
a content selector configured to select and database content related to an interaction service field from the image and voice of the service provider.

10. The avatar-based interaction service apparatus of claim 9, wherein the interaction service field includes a customer service, counseling, education, and entertainment, and
the interaction service provides content for the field to the first user terminal or the second user terminal through the interaction based on the avatar.

11. The avatar-based interaction service apparatus of claim 8, wherein in providing the interaction service to the first user terminal through the avatar of the service provider, the image of the service provider is analyzed to reflect a motion, a gesture, and an emotion of the service provider to the avatar.

12. The avatar-based interaction service apparatus of claim 8, wherein the real-time interaction unit modulates the voice of the service provider received from the service provider terminal into the voice of the avatar character and provides the modulated voice to the first user terminal.

13. The avatar-based interaction service apparatus of claim 8, wherein the AI avatar interaction unit analyzes a facial expression, a gesture, and a voice tone from a real-time image of the second user received from the second user terminal to perceive an emotional state of the second user so as to change a facial expression, a gesture, and a voice tone of the AI avatar in response to the perceived emotional state or attach an effect.

14. The avatar-based interaction service apparatus of claim 8, wherein the AI avatar interaction unit recognizes, understands, and responds to the voice of the second user received from the second user terminal through any one or more of automatic speech recognition (ASR), speech-to-text (STT), natural language understanding (NLU), natural language understanding (NLU) and text-to-speech (TTS).

15. An avatar-based interaction service method performed by a computer system, the method comprising:
providing an interaction service to a user terminal through an avatar reflecting an image and a voice generated by the computer system in a non-face-to-face conversation environment between the user at the user terminal and the avatar generated by the computer system;
receiving inputs from the user terminal; and
generating an avatar response based on the inputs received from the user terminal; and
sending the avatar response to the user terminal.

16. The avatar-based interaction service method of claim 15 wherein the avatar is generated based on reflecting an image and a voice of a service provider from a service provider terminal in a non-face-to-face conversation environment between the service provider at the service provider terminal and the user at the user terminal.

17. The avatar-based interaction service method of claim 16, wherein in the providing of the interaction service to the user terminal through the avatar of the service provider, the image of the service provider is analyzed to reflect a motion, a gesture, and an emotion of the service provider to the avatar.

18. The avatar-based interaction service method of claim further comprising training a response of the service provider to the first user based on a pre-stored learning model.

19. The avatar based interaction service method of claim further comprising providing the interaction service to another user terminal by generating the avatar based on the trained learning model

20. The avatar-based interaction service method of claim 15, wherein receiving inputs comprises receiving a facial expression, a gesture, and a voice tone of the user from the user terminal to perceive an emotional state of the user so as to change a facial expression, a gesture, and a voice tone of the avatar in response to the perceived emotional state or attach an effect.

21. The avatar-based interaction service method of claim 15, wherein generating an avatar response further comprises generating the avatar based on a trained learning model.

22. An avatar-based interaction service apparatus, comprising:
a communication unit configured to transmit and receive information through a communication network to a user terminal;
an avatar interaction unit configured to generate an avatar to provide an interaction service to the user terminal through the communication unit; and
a real-time interaction unit configured to provide an interaction service to the user terminal through the avatar in a non-face-to-face conversation environment between the avatar and a user at the user terminal.

23. The avatar-based interaction service apparatus of claim 22 wherein the avatar provided by the real-time interaction unit is an avatar of a service provider reflecting an image and a voice of the service provider at a service provider terminal in a non-face-to-face conversation environment between the user at the user terminal and the service provider at the service provider terminal.

24. The avatar-based interaction service apparatus of claim 23 wherein in providing the interaction service to the user terminal through the avatar of the service provider, the image of the service provider is analyzed to reflect a motion, a gesture, and an emotion of the service provider to the avatar.

25. The avatar-based interaction service apparatus of claim 23 wherein the real-time interaction unit modulates the voice of the service provider received from the service provider terminal into the voice of the avatar and provides the modulated voice to the user terminal.
